(19) United States
(12) Patent Application Publication
(10) Pub. No.: US 2019/0235607 A1
(43) Pub. Date: Aug. 1, 2019

(54) DISPLAY DEVICE WITH BUILT-IN TOUCH PANEL

(71) Applicant: Sharp Kabushiki Kaisha, Sakai City (JP)

(72) Inventor: Masayuki HACHINODA, Sakai City (JP)

(21) Appl. No.: 16/263,809

(22) Filed: Jan. 31, 2019

(30) Foreign Application Priority Data
Feb. 1, 2018 (JP) 2018-016754

(51) Int. Cl. G06F 1/3234; G06F 3/041; G06F 3/044

(52) U.S. Cl. CPC G06F 1/3265; G06F 3/0416; G06F 2203/04101; G06F 3/044; G09G 2330/021; G06F 3/0412

(57) ABSTRACT

Provided is a display device with a built-in touch panel, adapted to achieve power consumption saving during operation. A display device with a built-in touch panel includes: a sensor driving section that supplies, in an image display period, a counter voltage for the pixel electrode to the common electrode and supplies, in a touch detection period, a driving signal for touch detection to the common electrode to read out a detection signal; a proximity sensor processing section that detects an approach of an object to a display surface; and a control section configured such that, in the case where the proximity sensor processing section has detected an approach of an object to the display surface, (i) it stops output of a control signal for detecting a touch with a pen if a touch with a finger is detected, and (ii) it stops output of a control signal for detecting a touch with a finger if a touch with a pen is detected.

### BACKGROUND

### 1. Technical Field

The present disclosure relates to a display device with a built-in touch panel (also referred to as “touch panel built-in display device” hereinafter).

### 2. Description of Related Art

Heretofore, touch panel-equipped display devices with a touch sensor mechanism for detecting a position touched with a user's finger or a pen have been used widely. As one form of such touch panel-equipped display devices, a touch panel built-in display device of a so-called “in-cell type” is known, in which the touch sensor mechanism is provided inside a display panel. In particular, the display device configured such that all the components of the touch sensor mechanism are provided inside the display panel is called a “full in-cell type”.

In the touch panel built-in display device of a full in-cell type, electrodes in the display panel are also utilized as touch sensor electrodes. For example, a common electrode for supplying a common voltage to pixels on a liquid crystal display panel can be divided into a plurality of segments and these segments can be utilized as the touch sensor electrodes.

For such a touch panel built-in display device, there has been proposed a configuration that enables power consumption saving when achieving a gesture detection function in sleep mode (see JP 2017-4482 A, for example).

### SUMMARY OF THE DISCLOSURE

However, the configuration disclosed in JP 2017-4482 A is intended to reduce power consumption in sleep mode and does not achieve power consumption saving during operation.

With the foregoing in mind, it is an object of the following disclosure to provide a touch panel built-in display device adapted to achieve power consumption saving during operation.

In order to achieve the above object, a touch panel built-in display device according to an embodiment includes: a pixel electrode; a common electrode provided so as to oppose the pixel electrode; a sensor driving section that supplies, in an image display period, a counter voltage for the pixel electrode to the common electrode and supplies, in a touch detection period, a driving signal for touch detection to the common electrode to read out a detection signal; a proximity sensor processing section that detects an approach of an object to a display surface; and a control section that controls operation of the sensor driving section on the basis of a result of the detection by the proximity sensor processing section and a result of processing the detection signal from the sensor driving section. The control section is configured to: (i) stop output of a control signal for detecting a touch with a pen when the proximity sensor processing section has detected an approach of an object to the display surface and also has detected a touch with a finger; and (ii) stop output of a control signal for detecting a touch with a finger when the proximity sensor processing section has detected an approach of an object to the display surface and also has detected a touch with a pen.

According to the above-described configuration, it is possible to provide a display device adapted to achieve power consumption saving during operation.

### BRIEF DESCRIPTION OF DRAWINGS

FIG. 1 is a block diagram schematically showing the functional configuration of a touch panel built-in display device in a first embodiment.

FIG. 2 is a timing chart showing operation of the touch panel built-in display device in the first embodiment.

FIG. 3 is a table showing the relationship between the state of a touch panel and the presence or absence of output of control signals.

FIG. 4 is a flowchart illustrating the first half of a flow of the operation of the touch panel built-in display device in the first embodiment.

FIG. 5 is a flowchart illustrating the second half of the flow of the operation of the touch panel built-in display device in the first embodiment.

### DETAILED DESCRIPTION

A touch panel built-in display device according to a first configuration includes: a pixel electrode; a common electrode provided so as to oppose the pixel electrode; a sensor driving section that supplies, in an image display period, a counter voltage for the pixel electrode to the common electrode and supplies, in a touch detection period, a driving signal for touch detection to the common electrode to read out a detection signal; a proximity sensor processing section that detects an approach of an object to a display surface; and a control section that controls operation of the sensor driving section on the basis of a result of the detection by the proximity sensor processing section and a result of processing the detection signal from the sensor driving section. The control section is configured to: (i) stop output of a control signal for detecting a touch with a pen when the proximity sensor processing section has detected an approach of an object to the display surface and also has detected a touch with a finger; and (ii) stop output of a control signal for detecting a touch with a finger when the proximity sensor processing section has detected an approach of an object to the display surface and also has detected a touch with a pen.

According to this first configuration, in the case where the proximity sensor processing section has detected an approach of an object to the display surface, the control section stops: (i) output of a control signal for detecting a touch with a pen if a touch with a finger is detected; and (ii) output of a control signal for detecting a touch with a finger if a touch with a pen is detected. Accordingly, power consumption of the sensor driving section in the touch detection period can be reduced.

A touch panel built-in display device according to a second configuration is the touch panel built-in display device according to the first configuration, further adapted so that, when the proximity sensor processing section has detected an approach of an object to the display surface and also has detected both a touch with a finger and a touch with a pen, the control section stops the output of the control signal for detecting a touch with a finger.

In the case where both the touch with a finger and the touch with a pen have been detected, the reason why this happened is considered to be that the user who tried to perform a touch operation with a pen accidentally touched the display surface with his/her finger. According to the second configuration described above, by stopping the output of the control signal for detecting a touch with a finger in this case, it is possible to reduce power consumption of the sensor driving section while enabling detection of a touch with a pen that may occur subsequently.

A touch panel built-in display device according to a third configuration is the touch panel built-in display device according to the first or second configuration, further adapted so that, when the proximity sensor processing section has not detected an approach of an object to the display surface, the control section stops the output of the control signal for detecting a touch with a finger and the control signal for detecting a touch with a pen.

According to this third configuration, by stopping all the control signals for detecting the touches when the approach of the object has not been detected, it is possible to reduce power consumption of the sensor driving section.

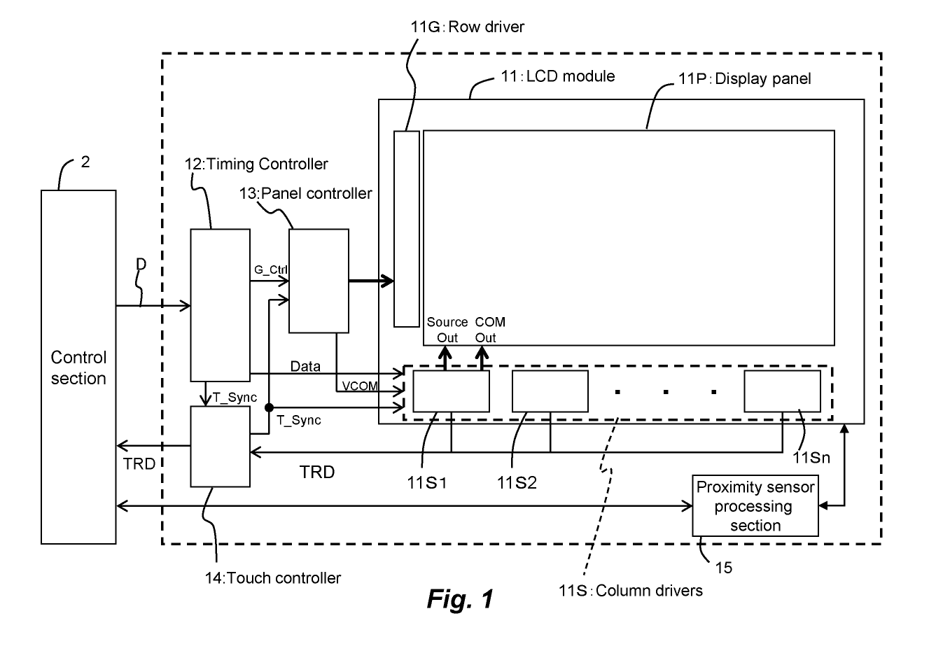

FIG. 1 is a block diagram schematically showing the functional configuration of a display device 100 according to one embodiment. The display device 100 includes a display unit 1 and a control section 2. The display unit 1 is a touch panel built-in display device of a so-called in-cell type, in which a touch sensor mechanism is provided inside a display panel. The control section 2 has a function of outputting display data D to the display unit 1 and also acquiring touch data from the display unit 1 and processing the touch data.

The display unit 1 includes a liquid crystal display (LCD) module 11, a timing controller 12, a panel controller 13, a touch controller 14, and a proximity sensor processing section 15.

The LCD module 11 includes a display panel 11P, a row driver 11G, and column drivers 11S. The display panel 11P includes, although not shown in FIG. 1, a plurality of gate lines to be selected sequentially row by row by the row driver 11G, a plurality of source lines to be driven by the column drivers 11S, and pixel electrodes connected to the gate lines and the source lines.

The display panel 11P includes a plurality of common electrodes (not shown) provided so as to oppose the pixel electrodes. The common electrodes serve as counter electrodes to the pixel electrodes during image display and serve as sensor electrodes during touch detection. The column drivers 11S are also connected to the common electrodes and also serve as a sensor driving section.

In the example shown in FIG. 1, n rows of the common electrodes are provided, and the number of the column drivers 11S is n, which is equal to the number of the rows of the common electrodes (that is, the column drivers 11S₁ to 11Sₙ are provided). It is to be noted, however, that the number of the rows of the common electrodes need not be the same as the number of the column drivers 11S.

In the LCD module 11, during image display, the row driver 11G selects the gate lines sequentially row by row, and data signals corresponding to the gradations to be displayed by the respective pixels on the selected gate lines are supplied from the column drivers 11S to the source lines. As described above, the common electrodes serve as the counter electrodes at this time.

Accordingly, signals at a constant COM potential are supplied from the column drivers 11S₁ to 11Sₙ to the common electrodes.

On the other hand, in the LCD module 11, during touch detection, AC signals with a constant amplitude (referred to as “touch driving signals” hereinafter) are supplied from the column drivers 11S₁ to 11Sₙ to the common electrodes. The column drivers 11S₁ to 11Sₙ read out touch detection signals (TRD) from the respective common electrodes in a touch detection period. The touch detection signals (TRD) thus read out are transmitted to the touch controller 14, and they are further outputted from the touch controller 14 to the control section 2. When a person's finger or a pen touches the display surface, a capacitance is formed between the object in contact with the display surface and the counter electrode. Accordingly, the touched position can be detected by collecting the touch detection signals (TRD) outputted from the respective common electrodes in the touch controller 14 and analyzing the change in touch detection signal (TRD) in all the common electrodes in the control section 2 to determine which of the common electrodes was touched.

Image display and touch detection are performed alternately. In other words, a period in which writing of an image is performed and a period in which a touch is detected are provided in a time-sharing manner. This will be described more specifically below.

Upon receipt of the display data D from the control section 2, the timing controller 12 outputs a gate control signal (G_Ctrl) for controlling the timing of driving the gate lines to the panel controller 13 and also outputs a data signal Data concerning image data to be displayed to the column drivers 11S. Also, the timing controller 12 outputs a touch synchronization signal (T_Sync) for synchronization between the image display and the touch detection to the touch controller 14. The touch synchronization signal (T_Sync) also is outputted from the touch controller 14 to the panel controller 13 and the column drivers 11S.

The panel controller 13 outputs a gate control signal (G_Ctrl) to the row driver 11G and also supplies VCOM with a constant potential to the column drivers 11S. VCOM is a voltage applied to the common electrodes, which serve as the counter electrodes to the pixel electrodes during image display.

The touch controller 14 controls touch detection processing by outputting the touch synchronization signal (T_Sync) to the panel controller 13 and the column drivers 11S. Also, the touch controller 14 receives the touch detection signals (TRD) from the column drivers 11S and outputs them to the control section 2.

The proximity sensor processing section 15 controls a proximity sensor (not shown) provided in the LCD module 11 and also detects an approach of some object within a certain distance from the display surface of the LCD module 11 on the basis of an output signal from the proximity sensor.

Various types of proximity sensors are known, including a capacitive proximity sensor, an inductive proximity sensor, an ultrasonic proximity sensor, an electromagnetic proximity sensor, and an infrared proximity sensor, for example.

The type of the proximity sensor to be used when carrying out the present invention is not particularly limited as long as the proximity sensor can detect an approach of some object.

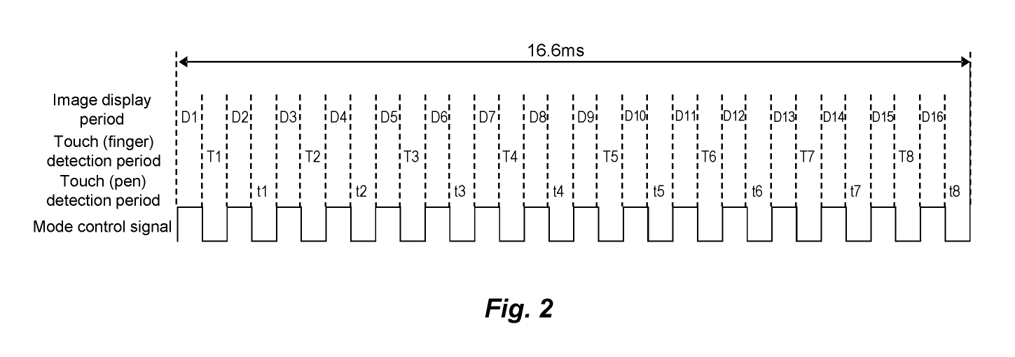

Next, time sharing control of image display processing and touch detection processing in the display device 100 will be described with reference to FIG. 2. FIG. 2 is a timing chart showing operation of the display device 100. FIG. 2 shows an example where the refresh rate of the screen of the display panel 11P is 60 Hz (i.e., one frame of the screen is displayed in 16.6 ms) and the image display and the touch detection are performed at 16 Hz in one frame.

As shown in FIG. 2, in 16.6 ms as a display period of one frame, a mode control signal (M_CTL) is switched from High to Low 16 times. In this example, during periods in which the mode control signal (M_CTL) is High (periods D1 to D16 shown in FIG. 2), the gate lines and the source lines are driven by the row driver 11G and the column drivers 11S, whereby an image is written on the display panel 11P.

In the example shown in FIG. 2, periods in which the mode control signal (M_CTL) is Low are allocated to the touch detection processing. As the periods for performing the touch detection processing, periods for detecting a touch with a finger and periods for detecting a touch with a pen are allocated alternately. That is, as shown in FIG. 2, in the display period of one frame, eight sections from T1 to T8 are allocated as the periods for detecting a touch with a finger and eight sections from t1 to t8 are allocated as the periods for detecting a touch with a pen.

In the case where a touch with a finger is to be detected and, in particular, the detection is performed by a capacitive sensing method, the presence or absence of a touch with a finger is detected on the basis of the amount of change in capacitance. On the other hand, in the detection of a touch with a pen (in particular, an active pen), various information is received by receiving a modulating signal transmitted from the pen and subjecting the modulating signal to demodulation processing to acquire digital data. Since methods for detecting a touch with a finger and a touch with a pen are known, detailed descriptions thereof are omitted.

In the case of a passive pen, detection of a touch therewith can be performed in the same manner as that for a touch with a finger, but the detection of a touch with the passive pen is different from the detection of a touch with the finger in that the tip of the pen, which is narrower than the finger, is to be detected. In the case of an active pen, the pen can exhibits functions such as writing pressure, inclination, and hover owing to a circuit included therein, whereby advanced additional functions can be realized by cooperation of the pen with a system.

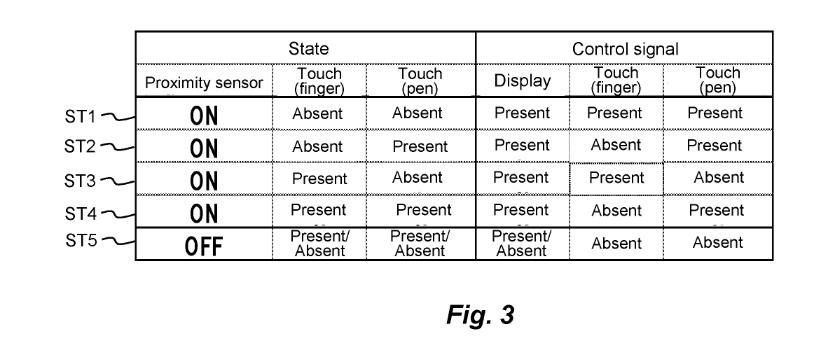

Next, with reference to FIG. 3, the operation control according to results of determination by the proximity sensor processing section 15 will be described.

The display device 100 according to the present embodiment is configured such that, when the proximity sensor processing section 15 has detected an approach of some object to the display surface, signal output in either a period for detecting a touch with a finger or a period for detecting a touch with a pen is limited depending on whether a touch with a finger or a touch with a pen has been detected. This will be described specifically below with reference to FIG. 3.

In FIG. 3, the state where the proximity sensor is “ON” (the states ST1 to ST4 in FIG. 3) corresponds to the case where the proximity sensor processing section 15 has detected an approach of some object to the display surface, and the state where the proximity sensor is “OFF” (the state ST5 in FIG. 3) corresponds to the case where the proximity sensor processing section 15 has not detected the presence of an object approaching the display surface.

The state ST1 in FIG. 3 shows the state where the proximity sensor processing section 15 has detected an approach of some object to the display surface and neither a touch with a finger nor a touch with a pen has been detected in the last two touch detection periods. In this state, the control section 2 of the display device 100 transmits instructions to the timing controller 12 so that, as shown on the right in FIG. 3, control signals for display, control signals for detecting a touch with a finger, and control signals for detecting a touch with a pen are all turned ON. Accordingly, in this state, the control signals are outputted in all of the image display periods D, the touch (finger) detection periods T, and the touch (pen) detection periods t shown in FIG. 2.

The state ST2 shows the state where the proximity sensor processing section 15 has detected an approach of some object to the display surface and a touch with a pen has been detected while a touch with a finger has not. In this state, the control section 2 of the display device 100 transmits instructions to the timing controller 12 so that, as shown on the right in FIG. 3, the control signals for display and the control signals for detecting a touch with a pen are turned ON and the control signals for detecting a touch with a finger (the touch driving signals etc. outputted from the column drivers 11S) are turned OFF. Accordingly, in this state, the control signals are outputted in the image display periods D and the touch (pen) detection periods t shown in FIG. 2, whereas the control signals are not outputted in the touch (finger) detection periods T. Consequently, power consumption in the touch (finger) detection periods T can be reduced.

The state ST3 shows the state where the proximity sensor processing section 15 has detected an approach of some object to the display surface and a touch with a finger has been detected while a touch with a pen has not. In this state, the control section 2 of the display device 100 transmits instructions to the timing controller 12 so that, as shown on the right in FIG. 3, the control signals for display and the control signals for detecting a touch with a finger are turned ON and the control signals for detecting a touch with a pen (the touch driving signals etc. outputted from the column drivers 11S) are turned OFF. Accordingly, in this state, the control signals are outputted in the image display periods D and the touch (finger) detection periods T shown in FIG. 2, whereas the control signals are not outputted in the touch (pen) detection periods t. Consequently, power consumption in the touch (pen) detection periods t can be reduced.

The state ST4 shows the state where the proximity sensor processing section 15 has detected an approach of some object to the display surface and a touch with a finger and a touch with a pen have both been detected. The cause of the detection of both the touch with a finger and the touch with a pen as described above is considered to be that the user who tried to perform a touch operation with the pen accidentally touched the display surface with his/her finger. Thus, in the example shown in FIG. 3, in this state, as in the state ST2, the control section 2 of the display device 100 transmits instructions to the timing controller 12 so that, as shown on the right in FIG. 3, the control signals for display and the control signals for detecting a touch with a pen are turned ON and the control signals for detecting a touch with a finger are turned OFF. Accordingly, the control signals are outputted in the image display periods D and the touch (pen) detection periods t shown in FIG. 2, whereas the control signals are not outputted in the touch (finger) detection periods T. Consequently, power consumption in the touch (finger) detection periods T can be reduced. It is to be noted that, in the state ST4, instead of giving priority to the detection of the touch with a pen as described above, priority may be given to the detection of the touch with a finger. That is, in the state ST4, the same control as in the state ST3 may be performed to allow the control signals to be outputted in the image display periods D and the touch (finger) detection periods T and not to allow the control signals to be outputted in the touch (pen) detection periods t.

The state ST5 shows the state where the proximity sensor processing section 15 has not detected an approach of an object. In this case, the control signals for detecting a touch with a pen and the control signals for detecting a touch with a finger are both turned OFF. Accordingly, the control signals are not outputted in the touch (finger) detection periods T and the touch (pen) detection periods t shown in FIG. 2. Consequently, in the state where the proximity sensor has not detected an approach of an object, power consumption in the touch (finger) detection periods T and the touch (pen) detection periods t can be reduced. The indication “Present/Absent” regarding the state ST5 in FIG. 3 means that the operation control does not depend on the state.

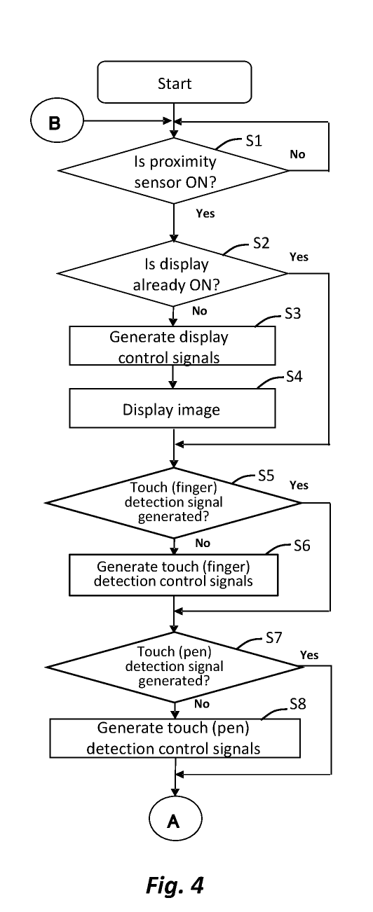

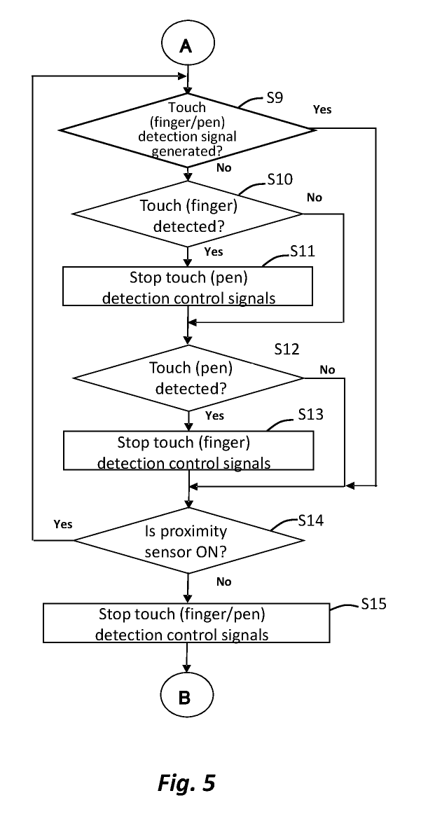

Next, the operation of the display device 100 will be described with reference to FIGS. 4 and 5. As shown in FIG. 4, when the proximity sensor is “ON”, i.e., some object has approached the display surface (Yes in Step S1), the control section 2 determines whether an image has already been displayed (Step S2). If an image has already been displayed (Yes in Step S2), the process advances to Step S5. If an image is not yet displayed (No in Step S2), the control section 2 turns display control signals ON (Step S3). As a result, an image is displayed (Step S4).

Next, the control section 2 determines whether a touch with a finger has already been detected (Step S5). If the touch with a finger has already been detected (Yes in Step S5), the process advances to Step S7. If the touch with a finger has not been detected (No in Step S5), the control section 2 turns control signals for detecting a touch with a finger ON (Step S6).

Next, the control section 2 determines whether a touch with a pen has already been detected (Step S7). If the touch with a pen has already been detected (Yes in Step S7), the process advances to Step S9. If the touch with a pen has not been detected (No in Step S7), the control section 2 turns control signals for detecting a touch with a pen ON (Step S8). Note here that “A” shown in FIG. 4 is continuous with “A” shown in FIG. 5.

Subsequently, as shown in FIG. 5, the control section 2 determines whether a touch with a finger or a pen has already been detected (Step S9). If the touch with a finger or a pen has already been detected (Yes in Step S9), the process advances to Step S14. If no touch has been detected so far (No in Step S9) and a touch with a finger is newly detected (Yes in Step S10), the control section 2 turns the control signals for detecting a touch with a pen OFF (Step S11). If a touch with a pen is newly detected (Yes in Step S12), the control section 2 turns the control signals for detecting a touch with a finger OFF (Step S13).

The process steps shown in Steps S9 to S13 are repeated while the proximity sensor is ON. When the proximity sensor is turned OFF, the process advances to Step S15. In Step S15, the control section 2 stops the control signals for detecting a touch with a finger and the control signals for detecting a touch with a pen. Thereafter, the process returns to Step S1 in FIG. 4

In the flowcharts shown in FIGS. 4 and 5, the process steps for realizing the state ST4 shown in FIG. 3 are omitted. When the proximity sensor is ON and both the touch with a finger and the touch with a pen have already been detected, it is considered that the user who tried to perform a touch operation with a pen accidentally touched the display surface with his/her finger. Accordingly, the control signals for detecting a touch with a finger may be stopped while keeping the control signals for detecting a touch with a pen ON. However, on the contrary, when the proximity sensor is ON and both the touch with a finger and the touch with a pen have already been detected, the control signals for detecting a touch with a pen may be stopped while keeping the control signals for detecting a touch with a finger ON.

As described above, the display device 100 is configured such that, when the proximity sensor has detected an approach of an object to the display surface and further has detected a touch with a finger, control signals for detecting a touch with a pen are stopped. Further, when the proximity sensor has detected an approach of an object to the display surface and further has detected a touch with a pen, control signals for detecting a touch with a finger are stopped. By stopping either the control signals for detecting a touch with a finger or the control signals for detecting a touch with a pen as described above, it is possible to achieve power consumption saving.

The above descriptions merely show specific examples of illustrative embodiments of the present invention, and those skilled in the art can make various changes and modifications. For example, although a display device provided with a LCD module is given as an example in the above descriptions, displays other than a liquid crystal display also can be used in the present invention.

### LIST OF REFERENCE NUMERALS

1 Display unit
2 Control section
11 LCD module
11G Row driver
11S Column driver (sensor driving section)
11P Display panel
12 Timing controller
13 Panel controller
14 Touch controller
15 Proximity sensor processing section
100 Display device

What is claimed is:

1. A display device with a built-in touch panel, the display device comprising:
a pixel electrode;
a common electrode provided so as to oppose the pixel electrode;
a sensor driving section that supplies, in an image display period, a counter voltage for the pixel electrode to the common electrode and supplies, in a touch detection period, a driving signal for touch detection to the common electrode to read out a detection signal;
a proximity sensor processing section that detects an approach of an object to a display surface; and
a control section that controls operation of the sensor driving section on the basis of a result of the detection by the proximity sensor processing section and a result of processing the detection signal from the sensor driving section,
wherein the control section is configured to: (i) stop output of a control signal for detecting a touch with a pen when the proximity sensor processing section has detected an approach of an object to the display surface and also has detected a touch with a finger; and (ii) stop output of a control signal for detecting a touch with a finger when the proximity sensor processing section has detected an approach of an object to the display surface and also has detected a touch with a pen.

2. The display device according to claim 1, wherein
when the proximity sensor processing section has detected an approach of an object to the display surface and also has detected both a touch with a finger and a touch with a pen, the control section stops the output of the control signal for detecting a touch with a finger.

3. The display device according to claim 1, wherein
when the proximity sensor processing section has not detected an approach of an object to the display surface, the control section stops the output of the control signal for detecting a touch with a finger and the control signal for detecting a touch with a pen.

4. The display device according to claim 2, wherein
when the proximity sensor processing section has not detected an approach of an object to the display surface, the control section stops the output of the control signal for detecting a touch with a finger and the control signal for detecting a touch with a pen.
